(19) United States
(12) Patent Application Publication
(10) Pub. No.: US 2007/0202914 A1
(43) Pub. Date: Aug. 30, 2007

(54) Wireless telephone handset with internet browsing capability

(75) Inventor: Bjarre Maaloe, Aalborg (DK)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/363,021

(22) Filed: Feb. 27, 2006

(51) Int. Cl. H04M 1/00

(52) U.S. Cl. 455/550.1

(57) ABSTRACT

A wireless handset having the capability of browsing full Internet web pages is disclosed. The handset includes a position sensing device, such as an optical sensor or a mouse ball and rollers, at its bottom surface. In an Internet browsing operating mode, a portion of a web page is displayed on a graphics display of the handset. Movement of the handset along a solid surface, similar to the movement of a computer mouse, will change the portion of the web page displayed. A cursor is displayed over the web page, and handset keys correspond to “left-click” and “right-click” functions in this mode. In a text entry mode, a portion of a keyboard layout is displayed, so that selection of characters using the cursor and movement of the handset is effected.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of wireless portable devices, and is more specifically directed to a wireless telephone handset for receiving data transmissions.

As is well known in the art, wireless telephones (also referred to as cellular telephones) now have a wide range of capabilities beyond voice communications. Even the most rudimentary wireless telephones now can receive text messages via the Short Message Service protocol. Most wireless telephone handsets are now capable of receiving and sending email messages, and many now include digital cameras, and the capability of sending and receiving still and video images.

In addition, wireless telephone service providers, and the handsets supported by those providers, now enable Internet web browsing as an additional service. Typically, Internet web browsing over cellular telephones is primarily text-based, with only limited graphics (for example, in the nature of “branding” the web page being viewed), because of the size and capability of the handset display screen, and also to limit the volume of data transmitted over the wireless telephone link.

It is contemplated, however, that the trend of higher data rates and greater wireless bandwidths will continue, and that the data capacity of wireless communications will soon be sufficient to communicate full web page content and downloads at very low costs. However, it is contemplated that the size of the display screen on wireless handsets, and other portable devices such as personal digital assistants (PDAs), digital audio players, and the like, will remain quite small. It is, of course, not possible to usefully view a full Internet web page on the small displays of these devices, especially to such an extent that small graphics images and links can be seen and selected for further browsing.

In addition, it is somewhat cumbersome to enter text into a conventional wireless telephone handset, despite such advances as predictive text entry (or the alleged advances of slang abbreviations). This difficulty tends to limit the length of text messages composed and transmitted by a handset user. It is of course especially cumbersome to text-enter even a reasonably short Universal Resource Locator (URL) when web browsing over a wireless telephone handset, if for no other reason than the inability of predictive text algorithms to anticipate URLs. Such text-based devices as the BLACKBERRY device available from Research in Motion Limited, and the TREO device available from Palm, Inc., include miniaturized keyboards that improve text entry on portable devices by enabling single-keystroke character entry. However, these miniaturized keyboards are themselves somewhat cumbersome, and also limit the miniaturization of the portable device itself.

By way of further background, other small display monitors and screens have provided scroll bars or navigation keys for viewing different portions of a larger image. However, these solutions typically require both hands to operate, and are typically non-intuitive to the extent that the user can get lost on the image.

### BRIEF SUMMARY OF THE INVENTION

It is therefore an object of this invention to provide a portable electronic device, such as a wireless telephone handset, that enables browsing of full Internet web pages.

It is a further object of this invention to provide such a device that is of a small size, such as that of conventional wireless telephone handsets.

It is a further object of this invention to provide such a device that permits intuitive navigation of web pages.

It is a further object of this invention to provide such a device that enables text entry for messaging and Internet web browsing, without substantially increasing the size of the device.

Other objects and advantages of this invention will be apparent to those of ordinary skill in the art having reference to the following specification together with its drawings.

The present invention may be implemented into a portable electronic device, such as a wireless telephone handset, having an operating mode in which its display screen displays a portion of an Internet web page. The device includes a positioning element, such as an optical motion sensor or a mouse ball. When the device is placed upon and moved along a flat surface in this operating mode, the portion of the web page visible on the display moves along with the motion of the handset. A cursor is also displayed, over the web page portion, enabling selection of links and images in the displayed web page portion. In this manner, the web page may be viewed at its full resolution.

According to another aspect of the invention, a special text input operating mode is provided, in which a keyboard is displayed on a portion of the handset display screen, perhaps in combination with or overlaying the currently displayed web page portion. Movement of the handset along the surface moves a cursor over the keyboard layout. The user can select a particular character by actuating a button or key of the handset, thus building a text entry in a character-by-character manner.

### BRIEF DESCRIPTION OF THE SEVERAL VIEWS OF THE DRAWING

FIG. 1 is an elevation view of a front surface of a wireless telephone handset according to a first preferred embodiment of the invention.

FIG. 2 is an elevation view of a front surface of a wireless telephone handset according to a second preferred embodiment of the invention.

FIGS. 3a and 3b are elevation views of a rear surface of the wireless telephone handset of FIG. 1 according to alternative implementations of the first preferred embodiment of the invention.

FIG. 4 is an electrical diagram, in block form, of a wireless telephone handset according to the preferred embodiments of the invention.

FIG. 5 is a flow chart illustrating the operation of the wireless telephone handset constructed according to the preferred embodiments of the invention.

FIGS. 6a through 6e are view of the display of the wireless telephone handset of the preferred embodiments of the invention, at various stages of its operation.

FIG. 7 is a perspective view illustrating the use of a wireless telephone handset to navigate web pages, according to the first preferred embodiment of the invention.

FIG. 8 is an elevation view of a front surface of a personal digital assistant according to a third preferred embodiment of the invention.

### DETAILED DESCRIPTION OF THE INVENTION

The present invention will be described in connection with its preferred embodiment, namely as implemented into a wireless telephone handset, because it is contemplated that this invention will be especially beneficial when used in that application. However, it is contemplated that this invention may also be beneficially applied to other devices, particularly those having relative small or miniaturized display screens, and having limited or miniaturized keypads. Examples of such other devices include personal digital assistants (PDAs), modem portable digital audio players, and the like. Accordingly, it is to be understood that the following description is provided by way of example only, and is not intended to limit the true scope of this invention as claimed.

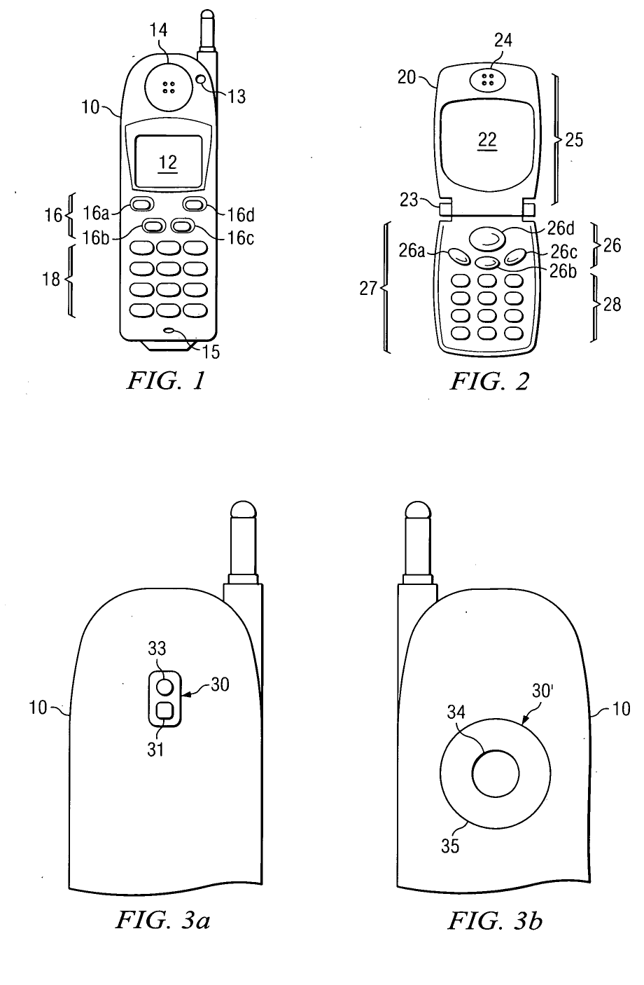

FIG. 1 illustrates the front face of an exemplary wireless telephone handset 10 constructed according to the preferred embodiment of the invention. As evident from FIG. 1, handset 10 includes many similar functions as a conventional handset. As such, handset 10 includes external antenna 11, on/off button or switch 13, speaker 14, and microphone opening 15, each of which are standard wireless telephone handset features well known in the art. Handset 10 also includes graphic display 12, preferably a full color display of conventional resolution, but having functionality for viewing full resolution web pages as will be described in further detail below. Numeric keys 18 are also provided on the front face of handset 10, preferably arranged in the conventional manner for telephone equipment, including the digits 0 through 9 and associated alphabet characters, along with the “*” and “#” keys in the lower left and right comers in the conventional pattern.

According to this embodiment of the invention, handset 10 also includes multifunction keys 16, numbering four keys 16a through 16d in this example. In operation as a conventional wireless telephone (i.e., for voice communications), multifunction keys 16 will have conventional wireless handset functions, such as on-hook and off-hook, and responses for menu selections displayed on display 12 (i.e., serving as “soft” keys). According to the preferred embodiment of the invention, however, as will be described below, multifunction keys 16 will serve as pointing device buttons (e.g., “click”, “right-click”, “back”, “forward”, “zoom in”, “zoom out”) for handset 10 when operating in an Internet browsing mode. Alternatively, one or more additional buttons may be provided at the top surface of the sides of handset 10 that are dedicated as pointing device buttons in the Internet browsing mode.

As evident from FIG. 1, handset 10 has the well-known “block” or “candy bar” form factor, in which all keys and the display are visible at all times. FIG. 2 illustrates a second preferred embodiment of the invention by reference to wireless telephone handset 20, which is in the well-known “fold” or “flip-phone” form factor. As shown in FIG. 2, therefore, handset 20 has an upper section 25 that includes display 22 and speaker 24, and lower section 27 that includes numeric keys 28, multifunction keys 26, and a microphone opening (not shown). Typically, one of multifunction keys 26 also serves as an on/off button or switch in this configuration. Upper section 25 is attached to lower section 27 by way of hinge 23, such that upper section 25 can close over lower section 27 in the conventional flip phone manner; typically, another display (not shown) is provided on the other surface (not shown) of upper section 25, to provide the user with status information when handset 20 is closed.

Of course, other handset configurations and form factors may also be used to realize a handset according to this invention. Such additional form factors include the “slide” form factor, in which a cover slides away from the display when used, some instances of which include a full alphanumeric keyboard and a rotating display.

As in handset 10 of FIG. 1, multifunction keys 26 of handset 20 effect conventional wireless telephone functions when handset 20 is in a normal telephone operating mode, such functions including on-hook and off-hook. In this example, keys 26a through 26c are conventional push-button keys (i.e., similar to each of numeric keys 28), and key 26j is a conventional “joystick” style rocker key that is leanable under pressure from the user to select one of four directions. As such, rocker key 26j is typically used for navigating through a menu or list that is shown on display 22. 7. According to this preferred embodiment of the invention, in an Internet browsing mode, multifunction keys 26 will serve as pointing device buttons for handset 20.

As discussed above in the Background of the Invention, modem wireless telephone handsets now can access and navigate Internet websites. These websites have typically been limited to text-based websites, with only limited graphics (on the order of “branding” for the websites and services visited), due to the limited size (in dimensions, and also in pixels) of displays 12, 22. For example, a typical handset display is on the order of 1.5 inches square, on the order of 100 pixels by 100 pixels. As such, it is not possible for a modem wireless telephone handset to faithfully or usefully display a full Internet web page. If an entire web page were displayed on the conventional handset display, the links and graphics would be of little use, if visible at all.

According to the preferred embodiments of the invention, handsets 10, 20 are capable of displaying a portion of a full Internet web page, and each include pointing device capability, similar to that of a computer “mouse”, that permits the user to select the portion of the web page to be displayed and thus navigate the displayed web page. As such, according to the preferred embodiments of the invention, the underside of handset 10, 20 (i.e., the opposite side of the handset from the display) includes a motion sensor that detects motion of handset 10, 20 along a solid surface, in an orientation in which display 12, 22 remains visible and useful to the user. FIGS. 3a and 3b illustrate this pointing device capability for handset 10, as will now be described.

FIG. 3a illustrates the underside of handset 10, relative to the top face shown in FIG. 1. According to this embodiment of the invention, handset 10 includes, on this underside, position sensor 30 in the form of an optical mouse sensor. As such, optical position sensor 30 includes light-emitting diode (LED) 31 and photosensor 33, disposed within a hollow into the underside of handset 10. LED 31 and photosensor 33 are constructed similarly as in a conventional optical mouse, with LED 31 illuminating a portion of a surface upon which handset 10 is placed (with display 12 facing up). Photosensor 33 senses changes in the illuminated portion of that surface as handset 10 is moved, and as such senses changes in the position of handset 10, for translation into a change in the position of the image (i.e., the portion of the web page) shown on display 12, in this embodiment of the invention. FIG. 3b illustrates an alternative implementation of position sensor 30′, including a removable ring 35 enclosing mouse ball 34. In this implementation, the underside of handset 10 includes rollers or other mechanical sensors that sense the rotational translation of mouse ball 34 as handset 10 is moved along a solid surface, from which changes in the portion of the image shown on display 12 can be deduced. It is contemplated that other position sensors may alternatively be used in connection with the preferred embodiments of the invention, including touch screen capability at display 12 (which, of course, will not be realized on the underside of handsets 10, 20).

In the case of flip-phone handset 20, it is contemplated that position sensor 30, 30′ will be disposed on the underside of lower section 27, considering that upper section 25 containing display 22 will preferably be opened to a relatively flat position, typically with a small tilt from the horizontal for ease of viewing. And in either case (handset 10 or handset 20), it is contemplated that position sensor 30, 30′ will preferably be disposed in a portion of the underside other than that of the battery or battery cover.

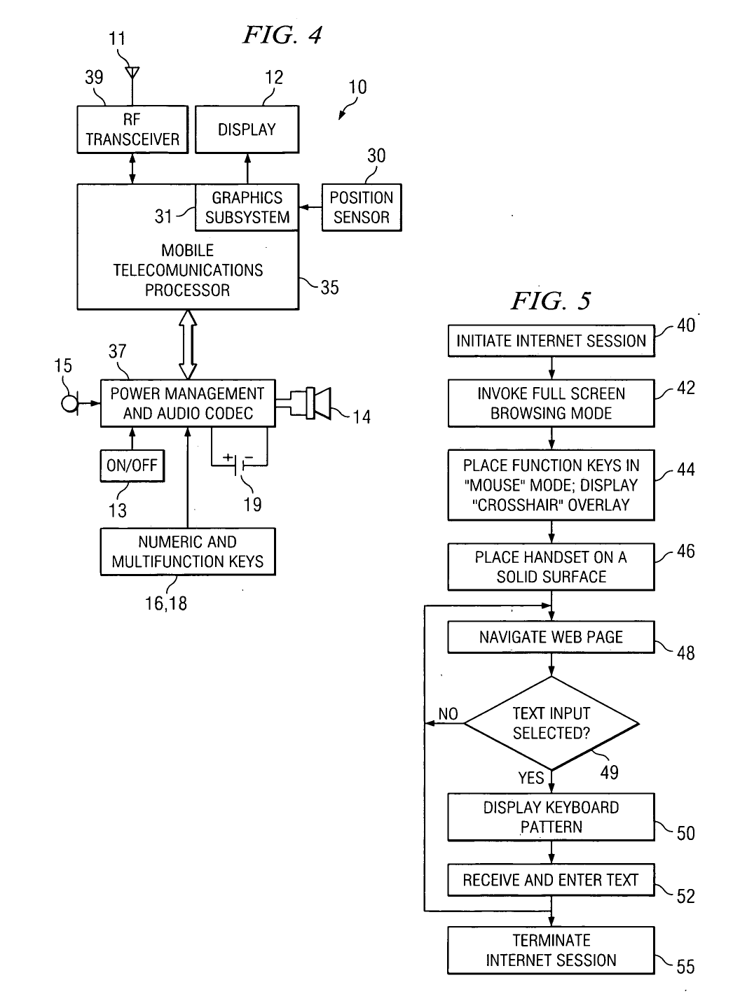

FIG. 4 illustrates an exemplary construction of the electronic circuitry of handsets 10 according to the preferred embodiments of the invention. Of course, from a system electronics standpoint, it is contemplated that the architecture of flip-phone handset 20 will be similar to that illustrated in FIG. 4. While the architecture of FIG. 4 relates to a preferred construction of handset 10, it is of course contemplated that handsets 10, 20 may be constructed according to variations of this architecture, and other architectures as useful in providing a wireless telephone handset with Internet access capabilities. It is therefore contemplated that the architecture of FIG. 4 is provided by way of example only, and that those skilled in the art having reference to this specification will be readily able to construct the electronic and system architecture of a particular handset as best suited for a particular application and considering the available technology.

For example, the architecture illustrated in FIG. 4 is a relatively advanced architecture, in which the integrated circuit “chip” count is minimized. As such, it is especially contemplated that the preferred embodiments of the invention may be realized in architectures involving a greater number of integrated circuits, and also in architectures that support additional functionality such as a digital camera function, Global Positioning System (GPS) capability, radio and digital audio functionality, and the like.

Further in the alternative, it is contemplated that the architecture of handset 10 could more closely follow that of a conventional computing device, including a main processor (e.g., a digital signal processor, or DSP, for handling the digital functions involved in modern wireless telephone communications) in combination with a graphics coprocessor that manages graphics display 12. This alternative architecture may be preferably to facilitate efficient display of a wide range of Internet content, including streaming video and the like, on graphics display 12 of handset 10. It is contemplated that this and other architecture approaches for realizing handset 10 will be apparent to those having reference to this specification.

In the exemplary architecture of FIG. 4, handset 10 is based on the so-called “single-chip” architecture, in which mobile telecommunications processor 35 is provided for handing much of the digital and analog processing for handset 10. In this example, processor 35 includes the appropriate circuitry for managing the operating system of handset 10, and also carrying out modulation and demodulation of the wireless signals to be transmitted or as received, baseband processing of such signals, management of the graphics information transmitted, received, and to be displayed on display 12, and the like. Also in this example, processor 35 includes graphics subsystem 31, which may be a graphics coprocessor or a display driver, or another realization of graphics functionality, and implemented either in hardware or software or a combination, such choices depending on the architecture. In this example, graphics subsystem 31 of processor 35 receives signals from position sensor 30, in response to which graphics subsystem 31 controls the images displayed by display 12, as will be described in further detail below; alternatively, position sensor 30 may communicate position information to graphics subsystem 31 via additional circuitry, or even through power management and audio codec circuitry 37, depending on the desired architecture. An example of an integrated circuit suitable for use as mobile telecommunications processor 35 is the OMAPV2230 UMTS solution available from Texas Instruments Incorporated. The OMAPV2230 processor, as well as other processors suitable for use in connection with the preferred embodiments of the invention, includes on-chip program memory for storing software routines for the control and signal processing involved in the operation of handset 10 according to the preferred embodiments of the invention. Alternatively, separate memory resources may be provided within handset 10 for this program memory, and also data memory as required. Furthermore, while FIG. 4 illustrates graphics subsystem 31 as within processor 35, in this single-chip solution of this exemplary implementation, it is of course contemplated that graphics subsystem 31, in the form of a graphics coprocessor, may be realized in a separate integrated circuit outside of processor 35. Processor 35 is preferably programmed in such a manner as to perform the operations described below in connection with the preferred embodiments of the invention, it being further contemplated that such programming may be readily implemented by one skilled in the art having reference to the description provided in this specification, without undue experimentation.

In the example of FIG. 4, processor 35 is in communication with power management and audio coder/decoder (“codec”) integrated circuit 37, which performs codec and interface functions with many of the peripherals of handset 10 in this example. For example, microphone 15 and speaker 14 are coupled to power management and audio codec 37, such that the codec function is capable of receiving input voice and audio from microphone 15 and formatting signals appropriate for processing by processor 35, and for receiving signals from processor 35 for output as audio signals over speaker 14, in the conventional manner. In addition, it is contemplated that power management and audio codec 37 also manages inputs from on/off switch 13, numeric keys 16, and multifunction keys 18, as shown, and communicates signals corresponding to those inputs to processor 35. The power management function of power management and audio codec 37 also receives power from battery 19, and distributes power throughout handset 10 in the conventional manner. An example of an integrated circuit suitable for use as power management and audio codec 37 is the TWL4030 integrated circuit available from Texas Instruments Incorporated.

Processor 35 is in communication with display 12, as mentioned above, such that the graphics and video information to be shown on display 12 is generated in the appropriate format by processor 35, and communicated thereto. Processor 35 is also coupled to radio frequency (RF) transceiver 39, which in turn is coupled to antenna 11. RF transceiver 39 thus controls the transmission and receipt of analog signals at the appropriate radio frequencies (up to and exceeding 1 GHz), in the conventional manner (i.e., according to the conventional GPRS, EDGE, or other communications standards for such communications links). An example of an RF transceiver that is suitable for use in connection with the preferred embodiments of this invention is the TRF6302 RF transceiver available from Texas Instruments Incorporated.

Again, it is contemplated that other architectures and integrated circuits may be used to realize the system electronics of handsets 10, 20, and that handsets 10, 20 themselves may include additional functionality, such as a digital camera, GPS, digital audio players, and the like, such functionality requiring additional system electronics for interfacing into and with processor 35, for example. As such, the architecture of FIG. 4 is presented by way of example only.

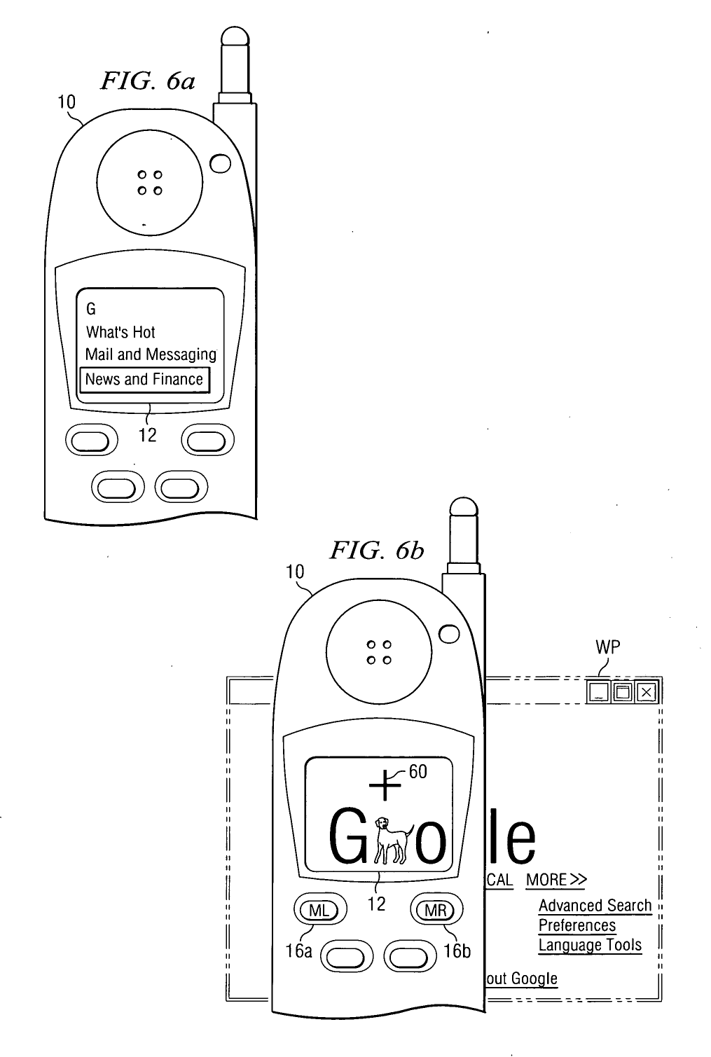

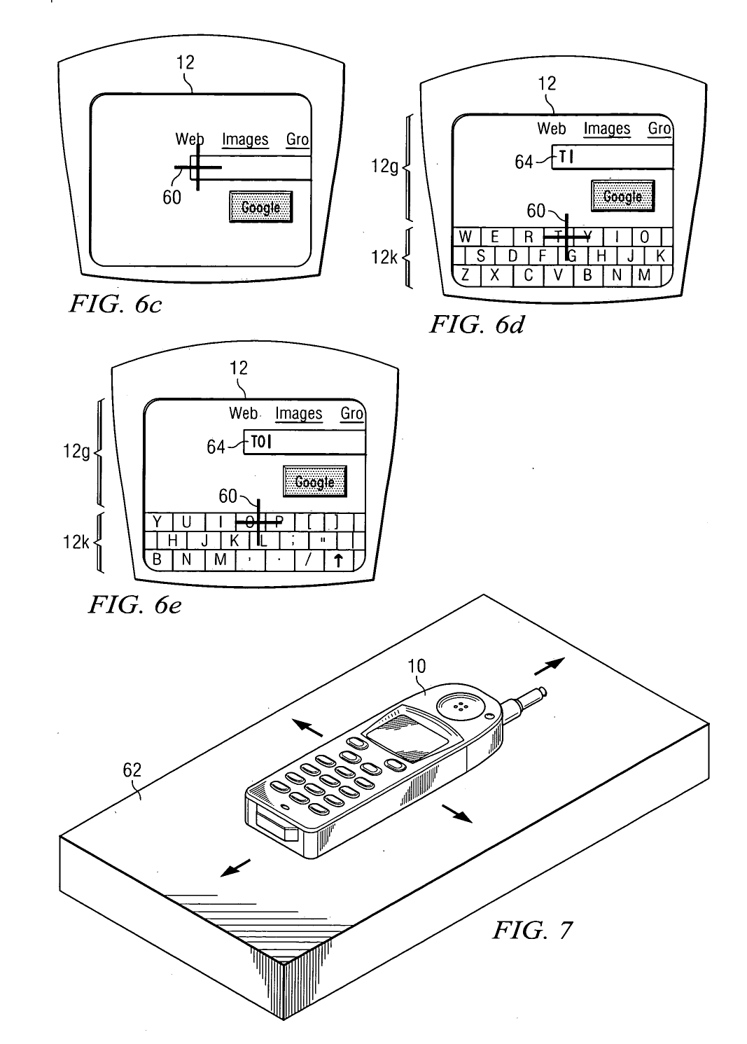

Referring now to FIG. 5 in combination with FIGS. 6a through 6e, the operation of a handset according the preferred embodiment of the invention will now be described, with reference to handset 10 by way of example. It is of course contemplated that handset 20, and alternatives to these exemplary devices, will operate in substantially a similar fashion. As mentioned above, it is contemplated that the process of FIG. 5 and the control of the display as illustrated in FIGS. 6a through 6e will be executed by processor 35 (FIG. 4), under the control of software routines. Of course, some or all of such functionality may be realized by way of custom or application-specific integrated circuit hardware, as desired by the designer. It is of course contemplated that alternatives to this described operational method may also be envisioned by those skilled in the art having reference to this specification, such alternatives also being within the scope of this invention as claimed.

Prior to process 40 of FIG. 5, it is contemplated that handset 10 has been turned on via on/off switch 13 or the like, and has “booted” to an operational condition. It is further contemplated that handset 10 will typically boot into a default state in which it is operable as a wireless telephone; as such, process 40 according to this embodiment of the invention initiates an Internet session at handset 10. Typically, process 40 is performed by way of a conventional menu-driven selection process, and will initiate a text-based Internet session for handset 10, in the conventional manner for modem Internet-capable cellular telephones. FIG. 6a illustrates display 12 after the completion of process 40, in which several text-based links are displayed; in this example, text-based link “News & Finance” is selected for navigation. As mentioned above, some limited amount of graphics may be displayed in this conventional mode, such graphics typically limited to “branding” of the website or service provider.

In process 42 according to this preferred embodiment of the invention, the user of handset 10 invokes a full screen browsing mode. Preferably, process 42 involves a menu-driven selection process as conventional for controlling the function and operation of modem wireless telephone handsets. In this embodiment of the invention, invocation of the full screen browsing mode displays a portion of a full web page within display 12. The term “full web page” in this context refers to a web page corresponding to that which is displayed on a conventional personal computer or laptop at a reasonable resolution (e.g., a resolution of 640×480 pixels or higher), rather than a text-based or otherwise limited version as typically accessed and displayed on conventional wireless telephone handsets. As mentioned above, it is generally not feasible to display an entire full web page within the small window provided by display 12, because many features will effectively disappear or become illegible as a result of the relatively coarse resolution of display 12 relative to the resolution of the full web page itself as well as the relatively small display size. As such, the full screen browsing mode invoked by process 42 results in part of the full web page being viewable within display 12. It is contemplated that the portion (e.g., ¼) of the web page so displayed may be selected by the user by way of a menu-driven selection, with a default portion selectable in the same manner. Alternatively, one or more of multifunction keys 16 may be programmed to provide “zoom” control of the displayed web page portion. For example, one multifunction key 16b may be assigned to the “zoom-in” function and another multifunction key 16c to the “zoom out” function.

FIG. 6b illustrates the display of a portion of a full web page by display 12 according to the preferred embodiment of the invention. As shown in FIG. 6b, the entire full web page would extend to well beyond the dimensions of handset 10, as shown by phantom web page boundary WP. As such, the portion of the web page viewable via display 12 will be of a reasonable and useful resolution, and can include full-resolution graphic images, as evident from FIG. 6b.

In process 44, some or all of the multifunction keys 16 of handset 10 are placed into a “mouse” mode to provide the user with the conventional “left-click” and “right-click” functionality. Referring to FIG. 6b, according to this example, multifunction key 16a is associated with the “left-click” function, and multifunction key 16d is associated with the “right-click” function, following process 44. Others of multifunction keys 16 may be associated with other “mouse” key functions, such as “back” and “forward” functions as useful in Internet web browsing.

In addition, process 44 displays a cursor on display 12. FIG. 6b illustrates an exemplary cursor 60, in the form of a cross-hair element. Cursor 60 serves as an indicator of a selectable position on the displayed web page portion, such that the user of handset 10 can “click” a specific web page element pointed to by cursor 60, by then pressing one of the multifunction keys 16 provided with a “mouse” function. The position of cursor 60 within display 12 remains substantially fixed as handset 10 is moved to direct cursor 60 to the desired location of web page WP, as will be described in detail below.

Process 44 may be performed automatically following process 42, or may be separately selectable and de-selectable by the user, for example by way of a menu-driven selection process, as desired. Further in the alternative, for example if handset 10 is constructed to include a joystick-like navigation key (such as rocker key 26j of handset 20 of FIG. 2), it is contemplated that process 44 will provide the corresponding functionality to such a key for purposes of web browsing, as appropriate. For example, rocker key 26j could be configured to serve a scrolling function, similar to the scrolling function of many conventional mouse or trackball pointing devices.

In process 46, upon (or prior to) invoking the full screen browsing mode in processes 42 and 44, the user of handset 10 places it on a solid surface, such as a table or desk. Indeed, it is contemplated that the solid surface need not be horizontal (i.e., handset 10 may be placed on a wall), and need not be flat (e.g., handset 10 may be placed on a curved surface such as a car trunk or car hood, or on a deformable surface such as the seat of a chair). Process 46 thus contemplates that handset 10 is placed on a surface sufficiently solid that position sensor 30 can sense movement of handset 10 along that surface. In the case of optical position sensor 30 (FIG. 3a), this surface preferably includes some variations so that this motion of handset 10 can be optically sensed). FIG. 7 illustrates the placement (and motion) of handset 10 along surface 62, which in this example appears as a table or desktop.

Once handset 10 has been placed on a surface in process 46, the user can move handset 10 to view various portions of the full web page, in navigation process 48. As mentioned above, the movement of handset 10 along this surface approximates that of a conventional computer mouse, except that cursor 60 remains fixed within display 12 while the portion of the web page viewable through display 12 moves with movement of handset 10 (this is, of course, opposite from conventional computer web browsing, in which the cursor moves about a stationary web page). This navigation can move from web page to web page, in the conventional manner, by the user moving handset 10 to place cursor 60 over a live link, and then clicking (via multifunction key 16a in this example). FIG. 6c shows such movement of handset 10 from an earlier position of the same web page shown in FIG. 6b.

According to this preferred embodiment of the invention, upon clicking a text entry box (e.g., pressing multifunction key 16a with cursor 60 within a text box, as shown in FIG. 6c), decision 49 returns a YES result and handset 10 either automatically enters, or can be enabled (by way of a menu) to enter, a text entry mode. In this text entry mode, according to this preferred embodiment of the invention, a keyboard pattern is at least partially displayed within display 12, in process 50. This keyboard pattern may be displayed in part of display 12, for example in portion 12k of display 12 as shown in FIG. 6d. Cursor 60 may be positioned lower within the frame of display 12 to appear within keyboard portion 12k as shown in FIG. 6d, in this mode; the remaining portion 12g of display 12 continues to view a portion of the web page, for ease of text entry. According to this preferred embodiment of the invention, cursor 60 can select one of the keyboard character locations displayed in portion 12k. Of course, in order for this to occur, with cursor 60 remaining in a fixed position within display 12, movement of handset 10 along the surface will move the displayed portion of the keyboard pattern, enabling different characters to be selected when underlying cursor 60. As evident in FIG. 6d, only a portion of a full keyboard need be shown within portion 12k of display 12. Movement of handset 10 along the solid surface can move the remaining portion of the keyboard pattern within view, with different characters underlying cursor 60. In addition, function keys (shift, “alt”, “ctrl”, etc.) may also be presented within the displayed keyboard pattern. Alternatively, if sufficient resolution is provided within display 12, an entire keyboard pattern may be displayed within portion 12k.

Accordingly, in process 52, text is received by handset 10 in response to the user clicking (e.g., via multifunction key 16a) when cursor 60 overlies the desired displayed character within the displayed keyboard pattern. This clicking operation will result in the selected character being entered into the text box location of the current web page. For example, as shown in FIG. 6d, cursor 60 overlies the character “T”, which upon clicking of multifunction key 16a, is transmitted to the web page and appears within the text box. A web page cursor 64 is displayed by the web page itself, indicating the position at which a next character will be entered. Entry of the next character can then be made by moving handset 10 along the solid surface to move cursor 60 to a different desired character position in the keyboard layout displayed in portion 12k. For example, FIG. 6e illustrates cursor 60 as positioned over the character “O”, which has been entered into the text box of the displayed web page by the clicking of multifunction key 16a, according to this exemplary embodiment of the invention. As evident from a comparison of FIGS. 6d and 6e, movement of handset 10, in this text entry mode, moves cursor 60 within the keyboard layout, while the displayed web page portion remains fixed.

Alternatively, numeric keys 18 may be pressed to enter text, without necessarily entering the text entry mode with the keyboard pattern displayed in process 50. According to this alternative, numeric keys 18 may be pressed using a predictive text algorithm, or by multiple presses to select characters associated with a given numeric key, as conventional for entering text for SMS messages and the like in modern wireless handsets. Movement of handset 10 and clicking (via multifunction key 16a) can then effect entry of the text in process 52.

In either case, the web page will respond to the entry of the text (typically by clicking a displayed graphical button) on the web page. According to this embodiment of the invention, this entry can be effected by moving handset 10 so that no portion of the keyboard pattern remains displayed, or alternatively by exiting the text entry mode (e.g., by pressing another one of multifunction keys 16 or by following a menu-driven deselection process), and then placing cursor 60 over the web page button provided for transmission of the entered text.

The text entry approach described above in connection with Internet webpage browsing may also be used in other applications. For example, as known in the art, SMS (Short Message Service) text messaging is now a popular application in modern wireless telephone handsets, along with email, calendar management, word processing, and the like. It is contemplated that the text entry approach of this preferred embodiment of the invention, in which part or all of a keyboard layout is displayed and navigated with the overlaid cursor, will also be advantageous in such applications.

By this combination of movement of handset 10, clicking of one or more of multifunction keys 16, and text entry, conventional Internet web pages can be displayed and navigated using handset 10. This can be continued in the conventional browsing manner, until the user terminates the Internet session in process 56, returning handset 10 to its default operational mode (typically as a telephone).

As described above, this invention opens up a much wider range of Internet content that can be usably accessed from a wireless telephone handset, well beyond the text-based pages, with limited graphics, that are currently available. Virtually any web page or web site available on the Internet can now be accessed, viewed, and used by a wireless telephone subscriber according to this invention, despite the limited size and resolution of the handset display. Conversely, the size and complexity of the wireless telephone handset need not be greatly enlarged in order to provide full Internet access, in light of this invention.

Further in the alternative, this invention may also be implemented into other devices, particularly portable devices having relatively small graphics displays, and that can be readily placed upon a solid surface and moved by hand, in the manner of a computer pointing device. Examples of such other devices include personal digital assistants (PDAs), modern portable digital audio players, and the like.

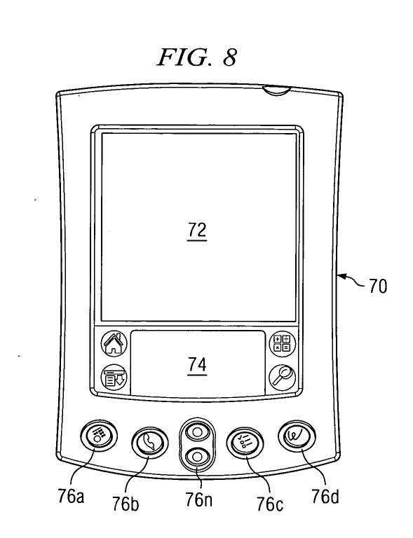

FIG. 8 illustrates PDA 70, into which this invention is implemented according to another preferred embodiment. As shown in FIG. 8, PDA 70 includes graphics display 72, which is of a relatively small size and thus relatively coarse resolution (relative to a conventional computer display), as known in the art. In this example, PDA 70 is of the type that can interpret stylus marks as text characters, and as such includes stylus pad 74 at which such marks can be made by the user and interpreted; alternatively, as known in the art, PDA 70 may include a small size keyboard. PDA 70 also includes several multi-function buttons 76a through 76d, and also navigation button 76n. Multi-function buttons 76a through 76d typically call specific applications from a main menu or state of PDA 70, or may also be programmed by the user (typically by way of a menu system) or within an application program itself to perform particular functions within an application, or from the main operating menu, as well known in the art. Navigation button 76n includes a conventional directional rocker and select button combination, as known in the art, for navigating within a graphical user interface window displayed on graphics display 72.

The system architecture for PDA 70 can be arranged in the conventional manner, typically by including a main central processing unit (CPU), program and data memory (either dedicated or combined), and support logic for performing its functions and executing its applications. It is also contemplated that PDA 70 according to this embodiment of the invention also includes wireless RF transceiver circuitry, for accessing the Internet by way of a “WiFi” link to a wireless access point in its vicinity and through that wireless access point and associated router circuitry to the Internet, directly by way of a conventional cellular-telephone like wireless Internet communications session (i.e., such as GPRS or EDGE communications), or indirectly by way of “Bluetooth” communications to a nearby personal computer and through that computer to the Internet. Such wireless connectivity for modem PDAs is well-known in the art.

According to this embodiment of the invention, PDA 70 also includes a position sensor (not shown) on its bottom side, so that in an Internet browsing mode or application, movement of PDA 70 on a solid surface (e.g., as shown in FIG. 7) can be sensed and interpreted by the processor of PDA 70. This position sensor can be an optical sensor as described above relative to FIG. 3a, a mouse ball as described above relative to FIG. 3b, or another type of sensor as contemplated above.

PDA 70 preferably operates in a similar manner, for full-website and webpage Internet access, as described for handset 10 in FIGS. 5 and 6a through 6e. As such, in an Internet browsing session, a portion of a full resolution Internet website can be displayed on graphics display 72 of PDA 70. By placing PDA 70 face-up onto a solid surface, movement of PDA 70 on that surface can be sensed by the bottomside position sensor and used to navigate within that website or webpage. A cursor will be positioned at a fixed location within display 72, as described above, to overlay the displayed webpage portion. One or more of buttons 76a through 76d, as well as button 76n, can be used as “mouse buttons” in this mode, to permit selection of links by way of the cursor. Others of buttons 76a through 76d and 76n can also be used as “back”, “forward”, “refresh” functions, and also to “zoom-in” or “zoom-out” the display of the web page portion shown in display 72.

For PDAs such as PDA 70 of FIG. 8, in which no keyboard is provided (or to which no external keyboard is attached), PDA 70 may also enable the display of a keyboard or keyboard portion, with overlying cursor, within graphics display 72, for the entry of text into the webpages as described above relative to FIGS. 6c through 6e. Alternatively, if PDA 70 is constructed to include a small-size keyboard, as known in the art for PDAs, then that keyboard may be used for such text entry. The Internet navigation capability described above can thus be executed by PDA 70, which provides the important advantages of viewing and navigating full resolution websites and webpages within the small graphics display 72 provided by PDA 70.

It is contemplated that those skilled in the art having reference to this description will readily recognize other handheld devices and the like into which this invention can be readily implemented, given the foregoing examples.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. An Internet-capable wireless handset, comprising:
a housing;
a graphics display disposed at a first surface of the housing;
a position sensing device disposed at a second surface of the housing, so that the graphics display is visible when the position sensing device is in contact with a surface;
communications circuitry for transmitting and receiving radio signals, the radio signals including signals corresponding to Internet communications; and
circuitry for controlling the graphics display to display a portion of an Internet web page corresponding to signals received by the communications circuitry, and for changing the displayed portion of the Internet web page responsive to movement of the handset detected by the position sensing device.

2. The handset of claim 1, further comprising:
a microphone;
a speaker;
audio codec circuitry for receiving audio signals from the microphone and outputting audio signals to the speaker;
wherein the communications circuitry is coupled to the audio codec circuitry, and is also for transmitting and receiving radio signals corresponding to cellular telephone communications.

3. The handset of claim 2, wherein the controlling circuitry comprises a processor device.

4. The handset of claim 2, further comprising:
numeric keys disposed at the first surface of the housing; and
multifunction keys disposed at the first surface of the housing, the multifunction keys coupled to the controlling circuitry to serve as pointing device buttons relative to the displayed portion of the Internet web page;
wherein the housing is in the form of a block form factor, so that the position sensing device is on an opposite side of the housing from the graphics display and the numeric and multifunction keys.

5. The handset of claim 2, wherein the housing comprises:
a first portion, having a bottom surface at which the position sensing device is disposed;
a second portion, having a top surface at which the graphics display is disposed;
a hinge coupling the first and second portions to one another;
numeric keys disposed at a top surface of the first portion of the housing; and
multifunction keys disposed at the top surface of the first portion of the housing, the multifunction keys coupled to the controlling circuitry to serve as pointing device buttons relative to the displayed portion of the Internet web page;

6. The handset of claim 1, wherein the position sensing device comprises:
a light-emitting diode; and
a photosensor.

7. The handset of claim 1, wherein the position sensing device comprises:
a mouse ball; and
mechanical sensors for sensing rotational translation of the mouse ball.

8. The handset of claim 1, wherein the circuitry for controlling the graphics display displays a cursor pattern overlying the displayed portion of the Internet web page, the cursor pattern remaining fixed in position within the graphics display responsive to movement of the handset detected by the position sensing device.

9. The handset of claim 8, wherein the circuitry for controlling the graphics display displays the cursor pattern in an Internet browsing mode;
wherein the circuitry for controlling the graphics display displays at least a portion of a keyboard pattern in a text entry mode and displays a cursor pattern overlying the keyboard pattern in the text entry mode;
and further comprising:
processing circuitry for sensing a character, in the text entry mode, corresponding to the position of the cursor pattern overlying the keyboard pattern, responsive to a press of one of the multifunction keys, the processing circuitry coupled to the communications circuitry, so that the communications circuitry transmits signals corresponding to the sensed character.

10. The handset of claim 9, wherein the circuitry for controlling the graphics display displays a different portion of the keyboard pattern responsive to movement of the handset sensed by the position sensing device in the text entry mode.

11. The handset of claim 9, wherein a processor device comprises the circuitry for controlling the graphics display and the processing circuitry.

12. A method of operating a wireless handset for Internet browsing, comprising the steps of:
initiating a wireless Internet session to receive wireless signals corresponding to an Internet web page;
in a full screen browsing mode, displaying a portion of the web page on a graphics display of the wireless handset;
sensing movement of the wireless handset along a solid surface; and
responsive to the sensing of movement of the wireless handset along the solid surface, changing the displayed portion of the web page on the graphics display.

13. The method of claim 12, further comprising:
displaying a cursor at a fixed location of the graphics display; and
responsive to a press of a multifunction key of the wireless handset and the cursor overlying an active link of the displayed portion of the web page, transmitting radio signals corresponding to activation of the link.

14. The method of claim 13, further comprising:
responsive to invoking a text entry mode, displaying at least a portion of a keyboard layout on the graphics display and displaying the cursor at a location overlying the displayed keyboard layout; and
responsive to a press of a multifunction key of the wireless handset and the cursor overlying a character of the displayed keyboard layout, transmitting radio signals corresponding to the character.

15. The method of claim 14, further comprising:
responsive to the sensing of movement of the wireless handset along the solid surface in the text entry mode, displaying a different portion of the keyboard layout on the graphics display.

16. The method of claim 14, wherein the step of invoking the text entry mode comprises:
sensing a press of a multifunction key of the wireless handset and the cursor overlying a text box of the displayed portion of the web page.

17. The method of claim 13, further comprising:
sensing a press of a multifunction key of the wireless handset and the cursor overlying a text box of the displayed portion of the web page; and
transmitting radio signals, corresponding to text characters, the text characters corresponding to presses of numeric keys of the wireless handset.

18. The method of claim 12, wherein the step of sensing movement of the wireless handset along a solid surface comprises:
receiving signals from a photosensor at a bottom surface of the wireless handset.

19. The method of claim 12, wherein the step of sensing movement of the wireless handset along a solid surface comprises:
receiving signals from mechanical sensors sensing rotational translation of a mouse ball disposed at a bottom surface of the wireless handset.

20. The method of claim 12, further comprising:
exiting the Internet session; and
initiating a cellular telephone communications session with the wireless handset.
